(19) United States
(12) Patent Application Publication
(10) Pub. No.: US 2014/0296027 A1
(43) Pub. Date: Oct. 2, 2014

(54) CONTROL APPARATUS FOR VEHICLE

(71) Applicant: Yoshimitsu TAKAHASHI, Toyota-shi (JP)

(72) Inventor: Yoshimitsu TAKAHASHI, Toyota-shi (JP)

(73) Assignee: TOYOTA JIDOSHA KABUSHIKI KAISHA, Toyota-shi (JP)

(21) Appl. No.: 14/230,319

(22) Filed: Mar. 31, 2014

(30) Foreign Application Priority Data
Apr. 1, 2013 (JP) 2013-076478

(51) Int. Cl. B60W 20/00

(52) U.S. Cl. CPC B60W 20/10; Y10S 903/902
USPC 477/5; 180/65.265; 903/902

(57) ABSTRACT

A control apparatus for a vehicle shifts a lock-up clutch to a slipping or released state when braking. The control apparatus causes an electric motor to output assist torque in a direction increasing a rotational speed of an engine, during control for shifting the lock-up clutch to a released state, when prescribed sudden braking is required during engine-powered travel in a locked-up state. Therefore, even if there is a time delay in actual implementation of shift from the locked-up state to the released state by the lock-up clutch, the rotational speed of the engine is increased (or maintained), or decrease in the rotational speed of the engine is suppressed, by the assist torque from the electric motor.

### INCORPORATION BY REFERENCE

The disclosure of Japanese Patent Application No. 2013-076478 filed on Apr. 1, 2013 including the specification, drawings and abstract is incorporated herein by reference in its entirety.

### BACKGROUND OF THE INVENTION

1. Field of the Invention

This invention relates to a control apparatus for a vehicle provided with a fluid transmission apparatus having a lock-up clutch, and more particularly, to technology for shifting the lock-up clutch to the release side when braking during engine-powered travel.

2. Description of Related Art

Vehicles provided with an engine, an electric motor, and a clutch interposed between the engine and the electric motor, and drive wheels are available. One example thereof is the vehicle disclosed in Japanese Patent Application Publication No. 2011-79478 (JP 2011-79478 A). JP 2011-79478 A discloses a technical feature of a vehicle which is further provided with a clutch between the engine and the electric motor, wherein, if the occurrence of an engine stall is predicted when the vehicle decelerates during engine-powered travel in a state where the two clutches are both engaged, at least one of the two clutches is set to the release side, whereby the engine is separated from the drive system which represents a load on the engine (or differential rotation is permitted between the rotational speed of the engine and the rotational speed of the vehicle wheels), and the occurrence of an engine stall is avoided.

In a vehicle provided with a fluid transmission apparatus having a lock-up clutch interposed between the engine and the drive wheels, similarly to the technology described above, shifting (operating) the lock-up clutch which is in a fully engaged state, to the release side (in other words, a slipping or released state), when the vehicle is coming to a stop due to a braking operation during engine-powered travel, is useful in avoiding the occurrence of an engine stall. However, in a lock-up clutch which is controlled by hydraulic pressure, a certain hydraulic response delay occurs with respect to the command value, and therefore in the event of sudden braking of the vehicle, in particular, the control of the lock-up clutch to the release side is delayed, the engine is drawn down to a rotational speed at which self-sustained operation is not possible, and there is a risk that an engine stall will occur. Problems such as that described above are not widely recognized, and no proposals have been made yet with regard to reliably avoiding the occurrence of an engine stall by control for shifting the lock-up clutch to the release side, in the event of sudden braking of a vehicle during engine-powered travel with the lock-up clutch in a fully engaged state.

### SUMMARY OF THE INVENTION

This invention was devised with reference to the aforementioned circumstances, an object thereof being to provide a control apparatus for a vehicle whereby the occurrence of an engine stall can be avoided in the event of sudden braking of the vehicle during engine-powered travel with a lock-up clutch in a fully engaged state.

Therefore, one aspect of this invention provides a control apparatus for a vehicle provided with an engine and an electric motor which are coupled so as to be able to transmit drive power to drive wheels, and a fluid transmission apparatus having a lock-up clutch interposed in the drive power transmission path between the drive wheels and the engine and the electric motor. This control apparatus is provided with an electronic control unit having the following configuration. More specifically, the electronic control unit is configured to implement control so as to shift the lock-up clutch to a slipping or released state in the event of braking during engine-powered travel in which the vehicle travels using at least the engine as a source of drive power, the electronic control unit being configured to implement control so as to output an assist torque from the electric motor to increase a rotational speed of the engine, during the control for shifting the lock-up clutch to the slipping or released state, if prescribed sudden braking is required during the engine-powered travel with the lock-up clutch in a fully engaged state.

According to the control apparatus for a vehicle described above, even if there is a time delay until the lock-up clutch is actually shifted to a slipping or released state, it is possible to increase (or maintain) the rotational speed of the engine (engine rotation speed), or to suppress decrease in the rotational speed of the engine, by the assist torque of the electric motor. Consequently, it is possible to avoid the occurrence of an engine stall in the event of sudden braking of the vehicle during engine-powered travel, with the lock-up clutch in a fully engaged state.

Here, in the control apparatus for a vehicle described above, the electronic control unit may be configured so as to set the assist torque from the electric motor to be larger, when a slip amount of the lock-up clutch is small, in comparison to when the slip amount is large, during the control for shifting the lock-up clutch to the slipping or released state. According to this control apparatus for a vehicle, by setting the assist torque from the electric motor to be larger in view of the fact that, the smaller the slip amount of the lock-up clutch, the greater the engine load and the greater the possibility of the rotational speed of the engine being drawn down, then the rotational speed of the engine can be increased (or maintained) readily, or decrease in the rotational speed of the engine can be suppressed readily, and the occurrence of an engine stall can be avoided readily.

Furthermore, in the control apparatus for a vehicle described above, the electronic control unit may be configured so as to set the assist torque from the electric motor to be larger, when the rotational speed of the engine is low, in comparison to when the rotational speed of the engine is high, during the control for shifting the lock-up clutch to the slipping or released state. According to this control apparatus for a vehicle, by setting the assist torque from the electric motor to be larger in view of the fact that, the lower the rotational speed of the engine, the greater the possibility of occurrence of an engine stall, then the rotational speed of the engine can be increased (or maintained) readily, or decrease in the rotational speed of the engine can be suppressed readily, and the occurrence of an engine stall can be avoided readily.

Furthermore, in the control apparatus for a vehicle described above, the electronic control unit may be configured to set a rate of change when outputting the assist torque from the electric motor to be larger, when a differential rotational speed between a target value and an actual value of the rotational speed of the engine is large, in comparison to when the differential rotational speed is small, during the control for shifting the lock-up clutch to the slipping or released state. According to this control apparatus for a vehicle, by setting the rate of change when outputting the assist torque from the electric motor to be larger, in view of the fact that, the greater the differential rotational speed between the target value and the actual value of the rotational speed of the engine, the further the rotational speed of the engine is drawn down and the greater the possibility of the occurrence of an engine stall, then the rotational speed of the engine is increased (or maintained) rapidly, or decrease in the rotational speed of the engine is suppressed rapidly, and the occurrence of an engine stall can be avoided readily.

Furthermore, in the control apparatus for a vehicle described above, the vehicle may be further provided with a transmission apparatus interposed in the drive power transmission path between the fluid transmission apparatus and the drive wheels, and the electronic control unit may be configured to set the assist torque from the electric motor to be larger, when a gear ratio of the transmission apparatus is on the high vehicle speed side, in comparison to when the gear ratio is on the low vehicle speed side, during the control for shifting the lock-up clutch to the slipping or released state. According to this control apparatus for a vehicle, by setting the assist torque from the electric motor to be larger in view of the fact that, the further the gear ratio of the transmission apparatus towards the high vehicle speed side, the greater the possibility of the rotational speed of the engine being drawn down, then the rotational speed of the engine can be increased (or maintained) readily, or decrease in the rotational speed of the engine can be suppressed readily, and the occurrence of an engine stall can be avoided readily.

Moreover, in the control apparatus for a vehicle described above, the electronic control unit may be configured so as to correct the assist torque from the electric motor on the basis of the slip amount of the lock-up clutch, by feedback (FB) control. Furthermore, the electronic control unit may be configured to correct the assist torque by raising the feedback gain, when the slip amount of the lock-up clutch is large, compared to when the slip amount is small, in the feedback control. According to this control apparatus for a vehicle, it is possible to prevent or suppress thermal damage caused by thermal loss in the lock-up clutch due to slipping of the lock-up clutch when the electric motor is outputting an assist torque.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating a schematic configuration of a drive power transmission apparatus provided in a vehicle to which the invention is applied, and illustrating the principal part of a control system in a vehicle;

FIG. 2 is a functional block line diagram illustrating the principal part of the control functions of the electronic control unit shown in FIG. 1;

FIG. 3A is a diagram showing one example of a relationship between a slip amount and an assist torque from an electric motor, which is set on the basis of the state of the vehicle, such as the slip amount of the lock-up clutch shown in FIG. 1;

FIG. 3B is a diagram showing one example of assist torque from an electric motor which is set on the basis of the state of the vehicle, such as the slip amount of the lock-up clutch shown in FIG. 1, and showing a relationship between the rotational speed of the engine, the engine torque and the assist torque;

FIG. 3C is a diagram showing one example of assist torque from an electric motor which is set on the basis of the state of the vehicle, such as the slip amount of the lock-up clutch shown in FIG. 1, and showing a relationship between the gear ratio of the transmission apparatus and the assist torque from the electric motor;

FIG. 4 is a flowchart illustrating the principal part of the control operation of the electronic control unit, more specifically, a control operation for avoiding the occurrence of an engine stall in the event of sudden braking of the vehicle during engine-powered travel in a locked-up state; and

FIG. 5 is one example of a time chart of a case where the control operation shown in the flowchart in FIG. 4 is executed.

### DETAILED DESCRIPTION OF EMBODIMENTS

In this invention, a case where the prescribed sudden braking is required means a case where a predetermined sudden braking operation is performed, and the sudden braking operation produces a vehicle deceleration whereby it is difficult to avoid an engine stall due to the decrease in the rotational speed of the engine, simply by shifting the lock-up clutch to a slipping or released state when braking is performed during engine-powered travel. In this way, it is possible to avoid the occurrence of an engine stall in the event of sudden braking of the vehicle during engine-powered travel with the lock-up clutch in a fully engaged state.

Furthermore, the embodiment can also be applied to various automatic transmission apparatuses, such as an automatic transmission based on a planetary gear system, a synchronous mesh parallel two-axle type automatic transmission, a dual clutch transmission (DCT), continuously variable transmission (CVT), or the like.

Furthermore, the electric motor MG is provided in the drive power transmission path between the engine and the drive wheels and is coupled to the engine via a clutch; the engine-powered travel is travel with the clutch in an engaged state.

Furthermore, the engine is an internal combustion engine, such as a petrol engine or diesel engine which generates drive power by burning fuel, for example. Moreover, the clutch provided in the drive power transmission path between the engine and the electric motor MG is a wet or dry engaging apparatus.

Below, embodiments of this invention are described in detail with reference to the drawings.

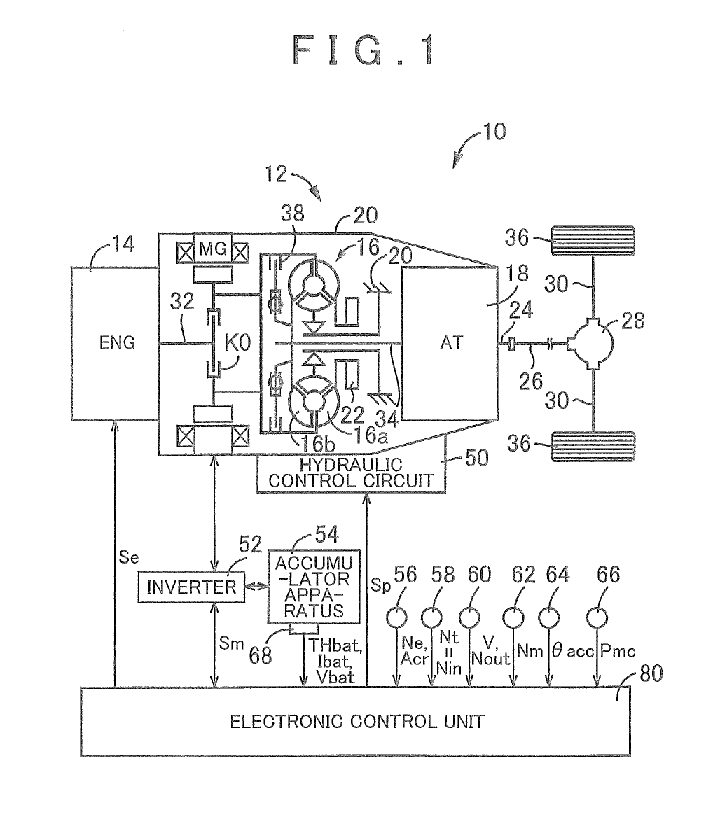

FIG. 1 is a diagram illustrating a schematic configuration of a drive power transmission apparatus 12 which is provided in a vehicle 10 to which the invention is applied, and also illustrates the principal part of a control system for implementing various controls in the vehicle 10. In FIG. 1, the vehicle 10 is a hybrid vehicle provided with an engine 14 and an electric motor MG which function as sources of drive power for travel. The drive power transmission apparatus 12 is provided with an engine engaging and disengaging clutch K0 (called “engaging/disengaging clutch K0” below), a torque converter 16 which is a fluid transmission apparatus, and an automatic transmission apparatus 18, and the like, arranged sequentially from the side of the engine 14, inside a transmission case 20 which is a non-rotating member. Furthermore, the drive power transmission apparatus 12 is provided with a propeller shaft 26 coupled to a transmission apparatus output shaft 24, which is an output rotating member of the automatic transmission apparatus 18, a differential gear 28 which is coupled to the propeller shaft 26, and a pair of axle shafts 30 which are coupled to the differential gear 28, and the like.

A pump impeller 16a of the torque converter 16 is coupled to an engine coupling shaft 32 via the engaging/disengaging clutch K0, and is also coupled directly to the electric motor MG. A turbine runner 16b of the torque converter 16 is coupled directly to a transmission apparatus input shaft 34, which is an input rotating member of the automatic transmission apparatus 18. A mechanical oil pump 22 which generates hydraulic pressure for implementing gear shift control of the automatic transmission apparatus 18 and engagement and release control of the engaging/disengaging clutch K0, and the like, due to being driven to rotate by the engine 14 (and/or the electric motor MG), is coupled to the pump impeller 16a. The drive power transmission apparatus 12 configured in this way is desirable for use in a front engine rear drive (FR) type vehicle 10, for example. In the drive power transmission apparatus 12, when the engaging/disengaging clutch K0 is coupled, the drive power of the engine 14 (this also applies to torque and/or force unless specified otherwise) is transmitted from the engine coupling shaft 32 which couples the engine 14 and the engaging/disengaging clutch K0, and successively via the engaging/disengaging clutch K0, the torque converter 16, the automatic transmission apparatus 18, the propeller shaft 26, the differential gear 28, and the pair of axle shafts 30, etc., to a pair of drive wheels 36. In this way, the drive power transmission apparatus 12 constitutes a drive power transmission path from the engine 14 to the drive wheels 36.

The torque converter 16 is interposed in the drive power transmission path between the engine 14 and the electric motor MG, and the drive wheels 36, and transmits drive power between the pump impeller 16a and the turbine runner 16b, via a fluid. The torque converter 16 is provided with a commonly available lock-up clutch 38 which directly couples the pump impeller 16a and the turbine runner 16b. Therefore, the lock-up clutch 38 can set the drive power transmission path between the engine 14 and the electric motor MG, and the drive wheels 36, to a mechanically coupled state. The lock-up clutch 38 is controlled so as to be engaged and released by a hydraulic control circuit 50 which is provided in the vehicle 10, using hydraulic pressure generated by the oil pump 22 as a source pressure.

The automatic transmission apparatus 18 is inserted in the drive power transmission path between the torque converter 16 and the drive wheels 36 and is a transmission apparatus that constitutes one portion of the drive power transmission path between the engine 14 and the electric motor MG, and the drive wheels 36, and transmits drive power from the drive power source for travel (the engine 14 and the electric motor MG) to the drive wheels 36. The automatic transmission apparatus 18 is, for example, a commonly available planetary gear type of step-less transmission apparatus, in which a plurality of gears having different speed ratios (gear ratios) γ (=transmission apparatus input rotational speed Nin/transmission apparatus output rotational speed Nout) are established selectively, or a commonly available continuous transmission apparatus in which the gear ratio γ is changed continuously in a step-less fashion. In the automatic transmission apparatus 18, a prescribed gear (gear ratio) is established in accordance with the operation of the accelerator by the driver, the vehicle speed V, and the like, due to the hydraulic actuator being controlled by the hydraulic control circuit 50, for example.

The electric motor MG is a so-called motor-generator having a function as a mover for generating a mechanical drive power from electrical energy, and a function as a generator for generating electrical energy from mechanical energy. The electric motor MG is coupled to the engine 14 so as to be able to transmit drive power to the drive wheels 36 via the torque converter 16, and functions as a drive power source for travel which generates drive power for travel, instead of the engine 14 or in addition to the engine 14, by electrical energy supplied from an accumulator apparatus 54 via an inverter 52. The electric motor MG is provided in the drive power transmission path between the engine 14 and the drive wheels 36, and performs operations for generating electrical energy by regeneration from drive power generated by the engine 14 and driven power input from the drive wheels 36, and storing the electrical energy in the accumulator apparatus 54 via the inverter 52, and so on. The electric motor MG is coupled to the drive power transmission path between the engaging/disengaging clutch K0 and the torque converter 16 (in other words, is coupled operationally to the pump impeller 16a), and drive power is transmitted respectively between the electric motor MG and the pump impeller 16a. Consequently, the electric motor MG is coupled to the engine 14 via the engaging/disengaging clutch K0, and is also coupled to the transmission apparatus input shaft 34 of the automatic transmission apparatus 18, so as to be able to transmit drive power, without passing via the engaging/disengaging clutch K0.

The engaging/disengaging clutch K0 is, for example, a wet multiple-plate type of hydraulic friction engaging apparatus, in which a plurality of mutually superimposed friction plates are pressed by hydraulic actuators, and the engagement and release of the clutch K0 is controlled by the hydraulic control circuit 50 using the hydraulic pressure generated by the oil pump 22 as source pressure. In this control of engagement and release, the torque capacity of the engaging/disengaging clutch K0 (called the “K0 torque” below) is varied in accordance with the pressure setting of a linear solenoid valve, or the like, in the hydraulic control circuit 50, for example. When the engaging/disengaging clutch K0 is in an engaged state, the pump impeller 16a and the engine 14 rotate in a united fashion via the engine coupling shaft 32. On the other hand, when the engaging/disengaging clutch K0 is released, the transmission of drive power between the engine 14 and the pump impeller 16a is disconnected. More specifically, the engine 14 and the drive wheels 36 are disconnected from each other when the engaging/disengaging clutch K0 is released. Since the electric motor MG is coupled to the pump impeller 16a, the engaging/disengaging clutch K0 is provided in the drive power transmission path between the engine 14 and the electric motor MG and also functions as a clutch for disconnecting the drive power transmission path.

The vehicle 10 is, for example, provided with a control apparatus relating to control of the engagement and release of the lock-up clutch 38, and the like. This control apparatus has an electronic control unit 80. The electronic control unit 80 includes a so-called micro-computer provided with a central processing unit (CPU), a random access memory (RAM), a read only memory (ROM), an input/output interface, and the like, and the CPU implements various controls of the vehicle 10 by carrying out signal processing in accordance with a program previously stored in the ROM, while using the temporary storage functions of the RAM. For instance, the electronic control unit 80 implements output control of the engine 14, drive control of the electric motor MG including regeneration control of the electric motor MG, gear shift control of the automatic transmission apparatus 18, and torque capacity control of the lock-up clutch 38 and the engaging/disengaging clutch K0, and the like, and depending on requirements, is divided into a part for engine control, a part for electric motor control and a part for hydraulic control, etc. The electronic control unit 80 respectively receives various signals (for example, the engine rotational speed Ne which is the rotational speed of the engine 14, and the crank angle Acr, the turbine rotational speed Nt, in other words, the transmission apparatus input rotational speed Nin which is the rotational speed of the transmission apparatus input shaft 34, the transmission apparatus output rotational speed Nout which is the rotational speed of the transmission apparatus output shaft 24 and corresponds to the vehicle speed V, the electric motor rotational speed (motor rotational speed, MG rotational speed) Nm, which is the rotational speed of the electric motor MG, the accelerator depression amount θacc corresponding to the drive requirement amount that the driver requires of the vehicle 10, the brake fluid pressure (master cylinder hydraulic pressure) Pmc which is generated from the brake master cylinder corresponding to the brake hydraulic pressure (operating hydraulic pressure) supplied to the wheel cylinder in accordance with a braking operation by the driver (for example, operation of the brake pedal), and the temperature (battery temperature, cell temperature) THbat, the charging current or discharging current (battery charging/discharging current, cell current) Ibat, and the voltage (battery voltage, cell voltage) Vbat, and the like, of the accumulator apparatus 54, these signals being based on detection values from various sensors (for example, an engine rotational speed sensor 56, a turbine rotational speed sensor 58, an output shaft rotational speed sensor 60, a motor rotational speed sensor 62, an accelerator depression amount sensor 64, a master cylinder pressure sensor 66, a battery sensor 68, and the like).

The electronic control unit 80 respectively outputs an engine output control command signal Se for controlling the output of the engine 14, a motor control command signal Sm for controlling the operation of the electric motor MG, hydraulic pressure control command signals Sp for operating the electromagnetic values (solenoid valves), etc., included in the hydraulic control circuit 50, in order to control the lock-up clutch 38, the engaging/disengaging clutch K0 and the hydraulic actuators of the automatic transmission apparatus 18, and the like, to engine control apparatuses, such as a throttle actuator and fuel injection device, the inverter 52, the hydraulic control circuit 50, and the like. The electronic control unit 80, also calculates the stored electric charge (state of charge (SOC), charge level) of the accumulator apparatus 54, the input limit (chargeable power) Win and the output limit (dischargeable power) Wout, on the basis of the battery temperature THbat, the cell current Ibat and the cell voltage Vbat, for example, and uses these as one of the abovementioned signals in the respective control procedures.

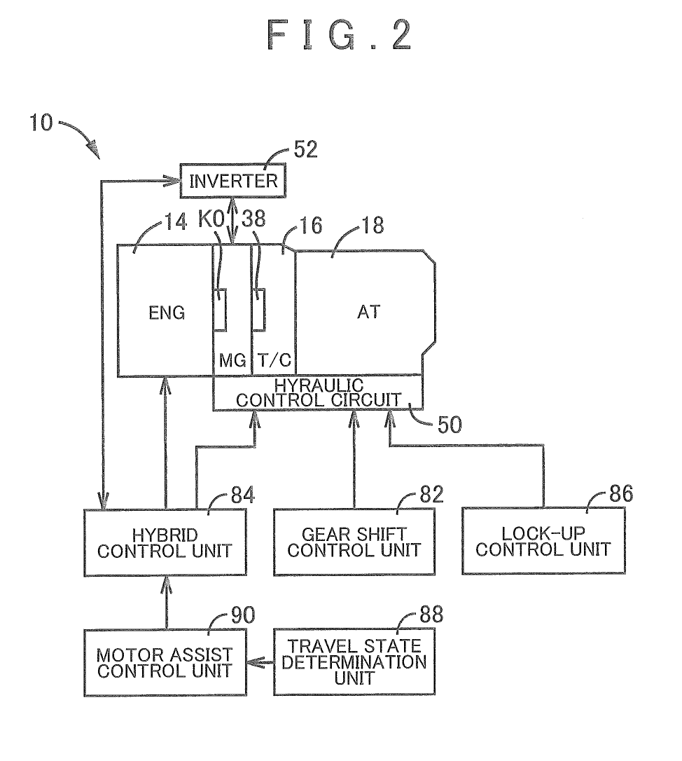

FIG. 2 is a functional block line diagram illustrating the principal part of the control functions performed by the electronic control unit 80. In FIG. 2, the gear shift control unit 82 having a gear shift control function determines whether or not a gear shift of the automatic transmission apparatus 18 ought to be implemented, on the basis of the state of the vehicle (for example, the actual vehicle speed V and accelerator depression amount θacc, etc.), from a common relationship (gear shift graph, shift map; not illustrated) which is previously derived and stored (predetermined), experimentally or theoretically, using the vehicle speed V and the drive requirement amount (for example, the accelerator depression amount θacc, etc.) as variables. A gear shift command value for obtaining the gear (gear ratio) found by this determination process is then output to the hydraulic control circuit 50. Automatic gear shift control of the automatic transmission apparatus 18 is then carried out. This gear shift command value is one of the hydraulic control command signals Sp.

A hybrid control unit 84 having hybrid control functions includes a function as an engine drive control unit for controlling the driving of an engine 14, and a function as a motor operation control unit for controlling the operation of the electric motor MG as a source of drive power, or a generator, via the inverter 52, and via these control functions, executes hybrid drive control by the engine 14 and the electric motor MG, and so on. For example, the hybrid control unit 84 calculates as a parameter the required drive force as a drive requirement amount (in other words, driver requirement amount) which is required of the vehicle 10 by the driver, on the basis of the accelerator depression amount θacc and the vehicle speed V, from a drive requirement amount map (not illustrated) which indicates a predetermined relationship between the vehicle speed V and the drive requirement amount, based on the accelerator depression amount θacc. The hybrid control unit 84 outputs command signals for controlling the sources of drive power for travel (the engine output control command signal Se and the MG control command signal Sm) in such a manner that the sources of drive power for travel (the engine 14 and the electric motor MG) produce an output whereby the required drive power is obtained, taking account of the transmission loss, the auxiliary equipment load, the gear ratio γ of the automatic transmission apparatus 18, and the input/output limits (chargeable/dischargeable electric power) Win/Wout of the accumulator apparatus 54, and the like. As the drive requirement amount, apart from the required drive force [N] in the drive wheels 36, it is possible to use the required drive torque [Nm] in the drive wheels 36, the required drive power (in other words, the required vehicle power) [W] in the drive wheels 36, the required transmission apparatus output torque in the transmission apparatus output shaft 24, and the required transmission apparatus input torque in the transmission apparatus input shaft 34, or the like. Furthermore, it is also possible to simply use the accelerator depression amount θacc [%], the throttle valve opening [%], the intake air volume [g/sec], or the like, as the drive requirement amount.

The hybrid control unit 84 implements motor-powered travel (electric vehicle (EV) travel) in which the vehicle travels by using only the electric motor MG as a source of drive power for travel, with the engaging/disengaging clutch K0 in a released state, if, for example, the required drive power is in a range that can be covered by output from the electric motor MG alone. On the other hand, the hybrid control unit 84 implements engine-powered travel, in other words, hybrid travel (electric hybrid vehicle (EHV) travel) in which the vehicle travels by using at least the engine 14 as a source of drive power for travel, with the engaging/disengaging clutch K0 in an engaged state, if, for example, the required drive power is in a range that cannot be covered without using the output from the engine 14 at least.

The lock-up control unit 86 having a lock-up control function determines the operating state of the lock-up clutch 38 that is to be controlled, on the basis of the state of the vehicle, from a commonly recognized relationship (lock-up region graph, lock-up clutch operation map; not illustrated) which is previously determined on the basis of, for example, the vehicle speed V and the drive requirement amount as variables, and outputs a lock-up hydraulic pressure command value (lock-up command pressure) for switching to the determined operating state, to the hydraulic control circuit 50, thereby controlling the switching of the operating state of the lock-up clutch 38. This lock-up command value is one of the hydraulic control command signals Sp.

Here, it is envisaged that the engine 14 is stopped when the vehicle 10 is braked during engine-powered travel in such a manner that the vehicle is decelerated and comes to a halt. Here, it is desirable for the engine 14 not to be stopped in cases where restarting of the engine 14 is difficult, due to the output limit Wout (or the charge capacity SOC) of the accumulator apparatus 54, or where the engine 14 is cold or is performing catalytic warm-up, or where it is wished to ensure warming properties inside the vehicle cabin. On the one hand, the engine 14 has a previously determined lower limit rotational speed (engine lower limit rotation speed Nemin) which enables self-sustained operation of the engine 14, at which the engine idling rotational speed Nei can be maintained by self-sustained operation, for example. On the other hand, during engine-powered travel with the lock-up clutch 38 in a fully engaged state (in other words, a locked-up state), the engine rotational speed Ne is restricted to the rotation of the drive wheels 36, and therefore during decelerating travel, the engine rotational speed Ne decreases in accordance with the decrease in the vehicle speed V. Therefore, when the vehicle speed V decreases during engine-powered travel in a locked-up state, there is a possibility of an engine stall occurring due to the engine rotational speed Ne decreasing below the engine lower limit rotational speed Nemin.

In view of this, when the vehicle is braked during engine-powered travel in a locked-up state, the lock-up control unit 86 outputs an lock-up command pressure for shifting the lock-up clutch 38 to a released state, to the hydraulic control circuit. 50, in order that self-sustained operation of the engine 14 can be maintained, provided that, for example, the vehicle speed V is less than a prescribed vehicle speed Vp [km/h], that the engine rotational speed Ne is less than a prescribed rotational speed Nep [rpm], and that a lock-up command pressure for setting the lock-up clutch 38 to a locked-up or slipped state has been output. The prescribed vehicle speed Vp is an engine stall prevention vehicle speed which is previously established in order to determine when the vehicle is in a low-speed region where resistance to engine stalling is reduced. Furthermore, the prescribed rotational speed Nep is an engine stall prevention rotational speed which is previously established in order to determine when the engine is in a low-rotational speed region where resistance to engine stalling is reduced. Furthermore, the lock-up command pressure which sets a slipping state is also determined, in addition to the lock-up command pressure which sets a locked-up state, because even in the slipping state, for example, there is a possibility that the available amount of slip (slipping rotational speed Ns (=Ne−Nin) may be small.

Therefore, when shifting from a locked-up state to a released state, a response delay occurs in the actual value of the lock-up hydraulic pressure (lock-up actual pressure), with respect to the lock-up command pressure. In so doing, the more sudden the braking during engine-powered travel, the more liable the engine rotational speed Ne is to decrease below the engine lower limit rotational speed Nemin, and the greater the risk of an engine stall occurring. In other words, in the case of sudden braking during engine-powered travel in a locked-up state, it may not be possible to avoid the occurrence of an engine stall, due to the hydraulic pressure response delay, simply by controlling from a locked-up state to a released state.

Therefore, the electronic control unit 80 executes engine stall prevention control by the electric motor MG which outputs assist torque TmA in a direction to increase the engine rotational speed Ne, during control for shifting from a locked-up state to a released state, if a prescribed sudden braking has been required during engine-powered travel in a locked-up state. Outputting an assist torque TmA in a direction to increase the engine rotational speed Ne by the electric motor MG means increasing the motoring torque of the electric motor MG, for example. A case where the prescribed sudden braking is required means a case where a sudden braking operation is performed which is previously established as a braking operation performed by the driver which will cause a sudden deceleration of the vehicle that makes it difficult to avoid the occurrence of an engine stall due to decrease in the engine rotational speed Ne, simply by shifting from a locked-up state to a released state, when braking during engine-powered travel, for example.

More specifically, returning to FIG. 2, a travel state determination unit 88 having a travel state determining function determines whether or not prescribed sudden braking has been required during engine-powered travel in a locked-up state (in other words, whether or not engine stall prevention control by the electric motor MG is required). The travel state determination unit 88 switches on an engine stall prevention determination flag, if it is determined that the prescribed sudden braking has been required. The travel state determination unit 88 determines whether or not the prescribed sudden braking has been required, on the basis of whether or not the master cylinder hydraulic pressure Pmc exceeds a prescribed hydraulic pressure Pmcp [Pa] and the rate of change of the master cylinder hydraulic pressure Pmc (brake hydraulic rate) dPmc (=dPmc/dt) exceeds a prescribed hydraulic pressure rate dPmcp [Pa/sec], for example. The prescribed hydraulic pressure Pmcp and the prescribed hydraulic pressure rate dPmcp are sudden braking operation determination values which are previously established as a braking operation perfolined by the driver for whom the prescribed sudden braking is required, for example. On the other hand, after switching on the engine stall prevention determination flag, the travel state determination unit 88 leaves the engine stall prevention determination flag switched on, even if the braking operation by the driver is released (the foot brake is switched off), for example, until a prescribed time period previously established as a time period for avoiding the occurrence of an engine stall has elapsed. Alternatively, the travel state determination unit 88 leaves the engine stall prevention determination flag switched on, from the time that the lock-up command pressure for setting a released state is output from the lock-up control unit 86, until a prescribed time period previously established to take account of the hydraulic pressure response delay has elapsed.

A motor assist control unit 90 having a motor assist control function sets the assist torque TmA from the electric motor MG, if the engine stall prevention determination flag has been switched on by the travel state determination unit 88, when control is implemented by the lock-up control unit 86 to shift the lock-up clutch 38 from a locked-up state to a released state. Here, the smaller the slip amount Ns of the lock-up clutch 38, the greater the engine load acting from the drive wheels 36, and the greater the possibility of the engine rotational speed Ne being drawn down. Furthermore, the lower the engine rotational speed Ne, the greater the possibility of an engine stall occurring. Moreover, the nearer the gear ratio γ of the automatic transmission apparatus 18 to the high vehicle speed side (in other words, the higher the gear ratio), the greater the possibility of the engine rotational speed Ne being drawn down.

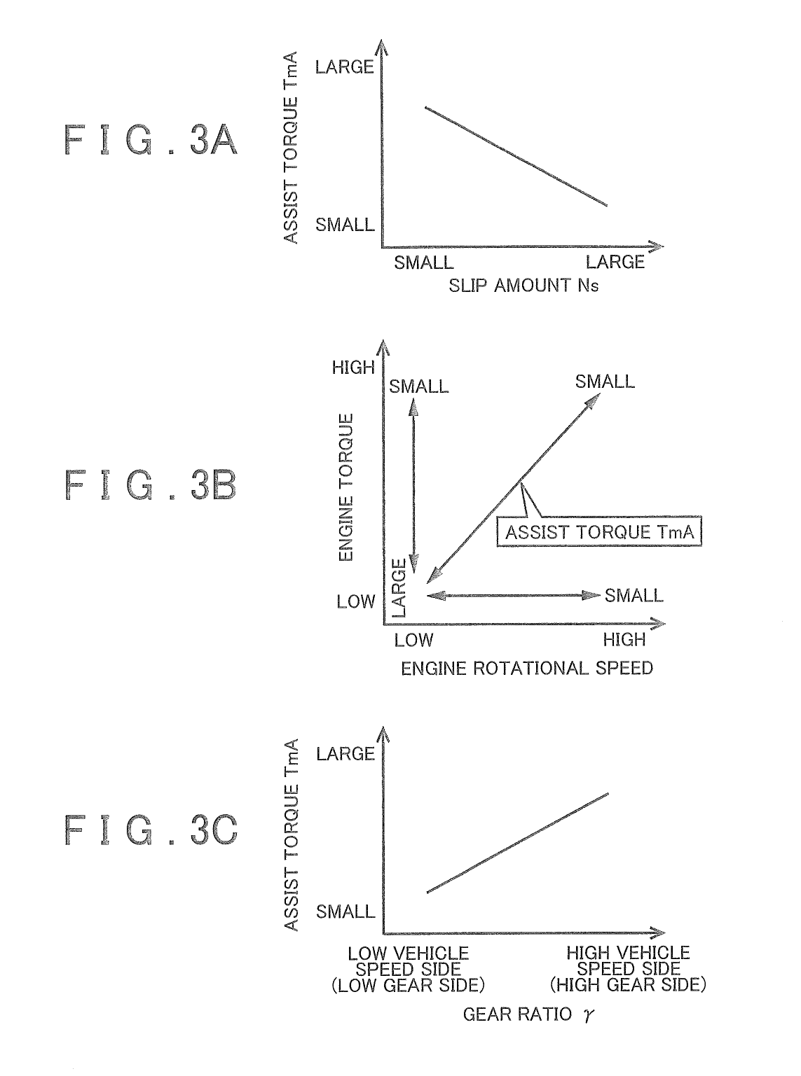

Therefore, as shown in FIG. 3A, the motor assist control unit 90 sets the assist torque TmA produced by the electric motor MG to be larger, when the slip amount Ns of the lock-up clutch 38 is small, in comparison to when the slip amount Ns is large. As shown in FIG. 3B, the motor assist control unit 90 sets the assist torque TmA produced by the electric motor MG to be larger, when the engine rotational speed Ne is low, in comparison to when the engine rotational speed Ne is high. Furthermore, as shown in FIG. 3C, the motor assist control unit 90 sets the assist torque TmA produced by the electric motor MG to be larger when the gear ratio γ of the automatic transmission apparatus 18 is on the high vehicle speed side, in comparison to when the gear ratio γ is on the low vehicle speed side. Furthermore, since the engine rotational speed Ne is more liable to be drawn down, the lower the engine torque Te, then as shown in FIG. 3B, the motor assist control unit 90 may set the assist torque TmA produced by the electric motor MG to be larger, when the engine torque Te is low, in comparison to when the engine torque Te is high.

The motor assist control unit 90 sets the target motor torque Tmton (=Tmt+TmA) when the engine stall prevention determination flag is switched on, by adding the assist torque TmA produced by the electric motor MG, which is set on the basis of the state of the vehicle, such as the slip amount Ns of the lock-up clutch 38, to the target value of the motor torque Tm (the target motor torque Tmt) during normal engine-powered travel when the engine stall prevention determination flag is not switched on.

When the engine stall prevention determination flag has been switched from off to on, the assist torque is switched from the normal target motor torque Tmt to the flag-on target motor torque Tmton. In this case, the rate of change of the target motor torque Tmton (target motor torque rate), in other words, the rate of change when the assist torque TmA produced by the electric motor is output, may be set to a previously established uniform value, but may also be set on the basis of the state of the vehicle. For example, the greater the engine differential rotational speed ΔNe (=Net−Ne) between the target value Net of the engine rotational speed Ne and the actual value (sensor detection value) Ne thereof, the greater the possibility of engine stall occurrence, with the engine rotational speed Ne being lowered. Therefore, the motor assist control unit 90 sets the target motor torque rate when the engine different rotational speed ΔNe is large to be larger, in comparison to when the engine differential rotational speed ΔNe is small. The target value Net of the engine rotational speed Ne is a value previously established, for example, as a mode of change of the engine rotational speed Ne which decreases due to the deceleration of the vehicle 10 when performing a braking operation which is not determined to require the prescribed sudden braking, for example. Alternatively, the target value Net of the engine rotational speed Ne may be a value which achieves continuation of the mode of change of the engine rotational speed Ne which decreases due to the deceleration of the vehicle 10 before performing a braking operation which is determined to require the prescribed sudden braking, for example.

In a temporary slipping state of the lock-up clutch 38 when an assist torque TmA is being output by the electric motor, a thermal load corresponding to the slip amount Ns and the coercive force acting from the drive wheels 36 is generated in the lock-up clutch 38. Therefore, it is desirable to prevent or suppress thermal loss in the lock-up clutch 38 caused by this thermal load. Therefore, the motor assist control unit 90 corrects the assist torque TmA by a feedback control, on the basis of the slip amount Ns of the lock-up clutch 38. For example, the motor assist control unit 90 calculates a correction amount for the assist torque TmA (feedback correction amount, feedback correction amount) by raising the feedback gain, when the slip amount Ns of the lock-up clutch 38 is large, compared to when the slip amount Ns is small With this feed back control, it is also possible to calculate the feedback correction amount so as to prevent or suppress loss of the locked-up state, for instance.

The motor assist control unit 90 calculates the final output torque of the MG, on the basis of the flag-on target motor torque Tmton, the target motor torque rate and the feedback correction amount, which have been calculated.

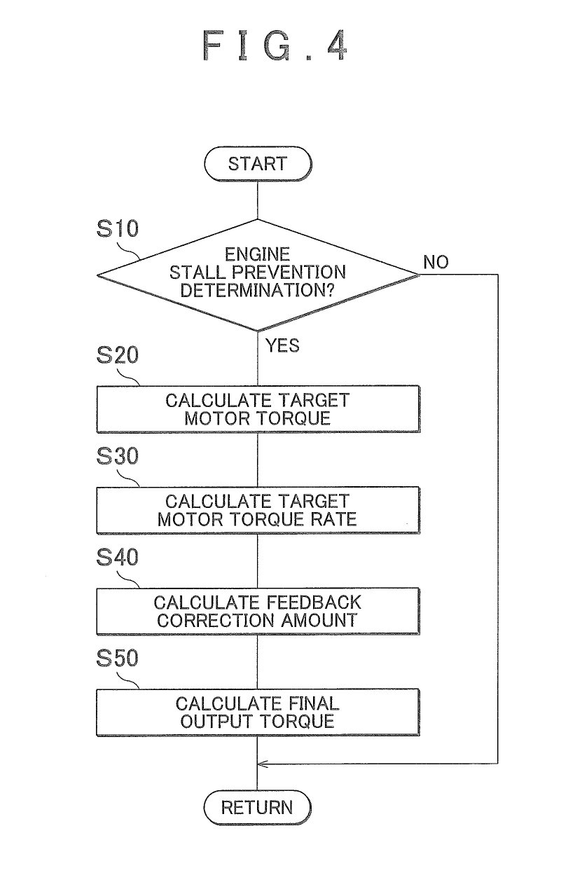

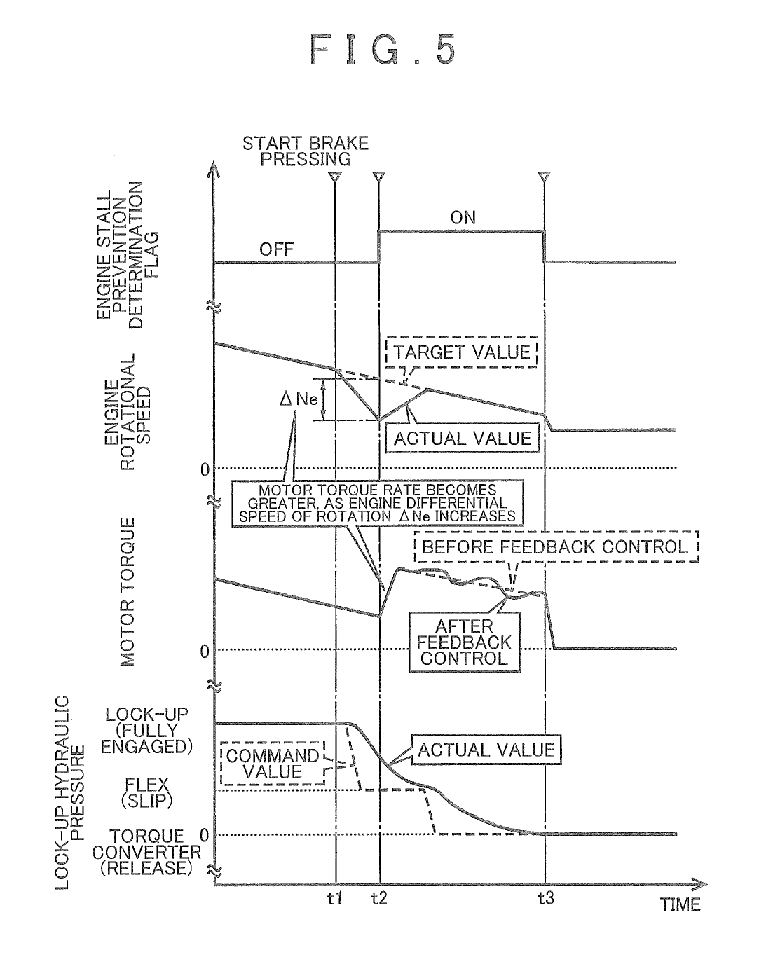

FIG. 4 is a flowchart illustrating the principal part of the control operation of the electronic control unit 80, in other words, a control operation for avoiding the occurrence of an engine stall in the event of sudden braking of a vehicle 10 during engine-powered travel in a locked-up state, and this procedure is repeated with an extremely short cycle time of approximately several msec to several ten msec, for example. FIG. 5 is a time chart of a case where the control operation shown in the flowchart in FIG. 4 is executed. The control operation in FIG. 4 is preconditioned on the fact that control is implemented to shift the lock-up clutch 38 from a lock-up state to a released state, during engine-powered travel in a locked-up state.

In FIG. 4, firstly, in step S10 (the word “step” is omitted below) which corresponds to the travel state determination unit 88, for example, it is determined whether or not a prescribed sudden braking has been required (in other words, whether or not engine stall prevention control is necessary). If the determination in S10 is negative, then this routine is terminated, and if positive, (see time t2 in FIG. 5), then in S20 which corresponds to the motor assist control unit 90, for example, the assist torque TmA produced by the electric motor MG is calculated on the basis of the state of the vehicle, such as the slip amount Ns of the lock-up clutch 38, and the target motor torque Tmton (=Tmt+TmA) with the engine stall prevention determination flag switched on is calculated on the basis of the normal target motor torque Tmt, and the calculated assist torque TmA.

Next, in S30 which corresponds to the motor assist control unit 90, for example, the target motor torque rate when switching from the normal target motor torque Tmt to the flag-on target motor torque Tmton is calculated on the basis of the engine differential rotational speed ΔNe. Thereupon, in S40 which corresponds to the motor assist control unit 90, a correction amount for the assist torque TmA (feedback correction amount) is calculated on the basis of the slip amount Ns of the lock-up clutch 38, for example. Thereupon, in S50 which corresponds to the motor assist control unit 90, the final output torque of the electric motor MG is calculated on the basis of the target motor torque Tmton, the target motor torque rate and the feedback correction amount calculated in S20 to S40 above, for example (see times t2 to t3 in FIG. 5).

In FIG. 5, before the time t1, decelerating travel with the accelerator off is performed, for instance. At t1, a braking operation is performed by the driver, which indicates the start of control for shifting the lock-up clutch 38 from a locked-up state to a released state. At time t1, the engine stall prevention determination flag may be switched on because a sudden braking operation is being performed, but since a margin is provided in order to reliably determine that sudden braking is required, the flag is not yet switched on. Thereupon, at time t2 where it has been reliably determined that sudden braking has been required, the engine stall prevention determination flag is switched on. From time t2 to time t3 where the engine stall prevention determination flag is on, an assist torque TmA is output from the electric motor MG. During this, the greater the engine differential rotational speed ΔNe, the greater the motor torque rate set when outputting the assist torque TmA. From time t3 onwards, the lock-up clutch 38 is set to a released state, and the engine 14 maintains the engine idling rotational speed Nei by self-sustained operation, even if there is no assist torque TmA from the electric motor MG.

As described above, according to this embodiment, since an assist torque TmA in a direction to increase the engine rotational speed Ne is output by the electric motor MG during control for shifting the lock-up clutch 38 to a released state, when a prescribed sudden braking is required during engine-powered travel in a locked-up state, then even if there is a delay in the time at which the lock-up clutch 38 actually shifts from the locked-up state to the released state, it is possible to raise (or maintain) the engine rotational speed Ne by the assist torque TmA from the electric motor MG, or to suppress decrease in the engine rotational speed Ne. Therefore it is possible to avoid the occurrence of an engine stall in the event of sudden braking of the vehicle 10 during engine-powered travel in a locked-up state.

Moreover, according to this embodiment, since the assist torque TmA from the electric motor MG is set to be larger, the smaller the slip amount Ns of the lock-up clutch 38, or the lower the engine rotational speed Ne or the further the gear ratio γ of the automatic transmission apparatus 18 toward the high vehicle speed side, during control for shifting the lock-up clutch 38 to a released state, then the engine rotational speed Ne can be increased (or maintained) readily, or decrease in the engine rotational speed Ne can be suppressed readily, and the occurrence of an engine stall can be avoided readily.

Furthermore, according to this embodiment, since the target motor torque rate is set to be larger, the greater the engine differential rotational speed ΔNe, during control for shifting the lock-up clutch 38 to a released state, then the engine rotational speed Ne is raised (or maintained) rapidly, or decrease in the engine rotational speed Ne is suppressed rapidly, and the occurrence of an engine stall can be avoided easily.

An embodiment of this invention has been described in detail above on the basis of the drawings, but this invention can also be applied to other modes.

For example, in the embodiment described above, control was implemented to shift the lock-up clutch 38 from a locked-up state to a released state, in the event of braking during engine-powered travel in a locked-up state, but the invention is not limited to this mode. For example, since it is sufficient that self-sustained operation of the engine 14 be maintained, then control may be implemented to shift the lock-up clutch 38 from a locked-up state to a slipping state (for example, a prescribed slipping state whereby self-sustained operation of the engine 14 can be maintained even when the vehicle is stopped or traveling at low speed). This invention can also be applied to a case such as this.

Furthermore, in the embodiment described above, it is determined whether or not a prescribed sudden braking is required, on the basis of the master cylinder hydraulic pressure Pmc, but the invention is not limited to this mode. For example, instead of using the master cylinder hydraulic pressure Pmc, it is possible to use the pressing force on the brake pedal by the driver as detected by a pressing force detection switch provided in the brake pedal, or a control value for the brake hydraulic pressure supplied to the wheel cylinders of the vehicle wheels in accordance with the master cylinder hydraulic pressure Pmc, by the wheel brake apparatus, or the mode of change of decrease in the vehicle speed V, or the like. Moreover, it is also possible to add the size of the engine differential rotational speed ΔNe, for example, to the determination conditions when determining whether or not prescribed sudden braking has been required.

Moreover, in FIG. 5 of the embodiments described above, a mode is described in which the engine stall prevention determination flag is not switched on immediately when a sudden braking operation is performed, but the invention is not limited to this mode. For example, it is also possible to switch on the engine stall prevention determination flag immediately when a sudden braking operation is performed. Alternatively, the engine stall prevention determination flag may be switched on immediately when a sudden braking operation is performed, and assist control by the electric motor MG may be implemented when it has been determined reliably that sudden braking has actually been required, by changing the time at which the assist torque TmA produced by the electric motor MG is set, or by changing the time at which the motor torque rate when outputting the assist torque TmA is set.

Furthermore, in FIG. 5 of the embodiment described above, when implementing control for shifting the lock-up clutch 38 from a locked-up state to a released state, a lock-up command pressure which achieves a slipping state is held temporarily, but the invention is not limited to this mode. For example, a mode may be adopted in which the hydraulic pressure is reduced at one time from a lock-up command pressure which achieves a locked-up state to a lock-up command pressure which achieves a released state. In a case where a lock-up command pressure achieving a slipping state is held temporarily as in the embodiment in FIG. 5, the assist torque TmA produced by the electric motor MG may be set in accordance with this slipping state, and so on.

Furthermore, in the respective embodiments described above, the engine stall prevention determination flag is left on until a prescribed time period has elapsed after outputting a lock-up command pressure which sets the lock-up clutch 38 to a released state, but the invention is not limited to this mode. For example, instead of using the lock-up command value, the engine stall prevention determination flag may be left on until the actual lock-up pressure assumes a value at which the lock-up clutch 38 can be determined to be in a released state.

Moreover, in the respective embodiments described above, the engine 14 and the MG are coupled indirectly via the engaging/disengaging clutch K0, but the invention is not limited to this mode. For example, the vehicle 10 may not be provided with the engaging/disengaging clutch K0, and the engine 14 and the electric motor MG may be coupled directly. This invention can also be applied to a case such as this.

Moreover, in the respective embodiments described above, a torque converter 16 was used as a fluid transmission apparatus, but another fluid transmission apparatus, such as a fluid coupling without a torque amplifying action, may also be used.

Furthermore, in the respective embodiments described above, an automatic transmission apparatus 18 is provided in the vehicle 10, but the vehicle 10 does necessarily have to be provided with an automatic transmission apparatus 18, provided that a mode is not implemented in which the assist torque TmA produced by the electric motor MG is set in accordance with the gear ratio γ of the automatic transmission apparatus 18.

While the invention has been described with reference to example embodiments thereof, it is to be understood that the invention is not limited to the described example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A control apparatus for a vehicle including an engine and an electric motor coupled so as to be able to transmit drive power to drive wheels, and a fluid transmission apparatus having a lock-up clutch interposed in a drive power transmission path between the drive wheels and the engine and the electric motor,
the control apparatus comprising:
an electronic control unit configured to:
(a) implement control so as to shift the lock-up clutch to a slipping or released state in the event of braking during engine-powered travel in which the vehicle travels using at least the engine as a source of drive power, and
(b) implement control so as to output an assist torque from the electric motor to increase a rotational speed of the engine, during the control for shifting the lock-up clutch to the slipping or released state, when prescribed sudden braking is required during the engine-powered travel, with the lock-up clutch in a fully engaged state.

2. The control apparatus according to claim 1, wherein the electronic control unit is configured to set the assist torque from the electric motor to be larger, when a slip amount of the lock-up clutch is small, in comparison to when the slip amount is large, during the control for shifting the lock-up clutch to the slipping or released state.

3. The control apparatus according to claim 1, wherein the electronic control unit is configured to set the assist torque from the electric motor to be larger, when the rotational speed of the engine is low, in comparison to when the rotational speed of the engine is high, during the control for shifting the lock-up clutch to the slipping or released state.

4. The control apparatus according to claim 1, wherein the electronic control unit is configured to set a rate of change when outputting the assist torque from the motor generator to be larger, when a differential rotational speed between a target value and an actual value of the rotational speed of the engine is large, in comparison to when the differential rotational speed is small, during the control for shifting the lock-up clutch to the slipping or released state.

5. The control apparatus according to claim 1, wherein the vehicle is further provided with a transmission apparatus interposed in the drive power transmission path between the fluid transmission apparatus and the drive wheels, and the electronic control unit is configured to set the assist torque from the electric motor to be larger, when a gear ratio of the transmission apparatus is on the high vehicle speed side, in comparison to when the gear ratio is on the low vehicle speed side, during the control for shifting the lock-up clutch to the slipping or released state.

6. The control apparatus according to claim 1, wherein the electronic control unit is configured to correct the assist torque from the electric motor, by feedback control, on the basis of a slip amount of the lock-up clutch.

7. The control apparatus according to claim 6, wherein the electronic control unit is configured to correct the assist torque by raising a feedback gain, when the slip amount of the lock-up clutch is large, compared to when the slip amount is small.
